(19) United States
(12) Patent Application Publication
(10) Pub. No.: US 2017/0317323 A1
(43) Pub. Date: Nov. 2, 2017

(54) TRANSPOSABLE BATTERY PACK FOR UNINTERRUPTIBLE POWER SUPPLY

(71) Applicant: HEWLETT PACKARD ENTERPRISE DEVELOPMENT LP, Houston, TX (US)

(72) Inventors: Hai Ngoc NGUYEN, Houston, TX (US); Abhishek BANERJEE, Houston, TX (US)

(73) Assignee: HEWLETT PACKARD ENTERPRISE DEVELOPMENT LP, Houston, TX (US)

(21) Appl. No.: 15/143,108

(22) Filed: Apr. 29, 2016

(51) Int. Cl. H01M 2/10; H01M 2/20; H01M 16/00; H02J 9/06

(52) U.S. Cl. CPC H01M 2/1077; H02J 9/061; H01M 2/20; H01M 16/00; H01M 2220/10

(57) ABSTRACT

According to an example, a plurality of battery modules may be dimensioned to fit within a form factor.

### BACKGROUND

An uninterruptible power supply (UPS) is an electrical component that provides emergency power to a load. For example, when a main power supply to a load fails, the UPS provides emergency power to the load. Examples of a load may include any type of computer, data center, telecommunication equipment, or other electrical equipment that uses AC and/or DC power. A UPS includes internal or external batteries that provide near-instantaneous protection from input power interruptions. A UPS may also include other power supply components such as super capacitors, flywheels, etc. A UPS may include an on-battery runtime of a few minutes to several hours. During use of the UPS power supply, the equipment that is connected to the UPS may be properly shut down, or otherwise, the power supply to the equipment may be switched to another source.

### BRIEF DESCRIPTION OF DRAWINGS

Features of the present disclosure are illustrated by way of example and not limited in the following figure(s), in which like numerals indicate like elements, in which:

FIG. 1 illustrates front, top, and back views of a transposable battery pack for an uninterruptible power supply (UPS), and a plurality of battery module types, according to an example of the present disclosure;

FIG. 2 illustrates a front view of the transposable battery pack of FIG. 1 installed in the UPS, a top view of the UPS, and a back view of the UPS, according to an example of the present disclosure;

FIGS. 3A and 3B respectively illustrate an enclosed plastic casing and an enclosed metal casing for a battery module of the transposable battery pack of FIG. 1, according to an example of the present disclosure;

FIG. 4 illustrates a 2× height battery module type for the transposable battery pack of FIG. 1, according to an example of the present disclosure;

FIG. 5 illustrates 2× width battery module type for the transposable battery pack of FIG. 1, according to an example of the present disclosure;

FIG. 6 illustrates a quad battery module type for the transposable battery pack of FIG. 1, according to an example of the present disclosure; and

FIG. 7 illustrates a front view of a UPS including a predetermined internal form factor, a top view of the UPS, and a back view of the UPS, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, and the term “including” means including but not limited to. The term “based on” means based at least in part on.

According to examples, a transposable battery pack for an uninterruptible power supply (UPS) may include a height and a width dimensioned to fit within a frame of the UPS. The UPS may include a 1U (rack unit) dimension-based UPS. A 1U dimension of the 1U dimension-based UPS represents an approximately 1.75 inches (44.45 mm) height.

The transposable battery pack may include a predetermined form factor designed to fit within a frame of the 1U dimension-based UPS. As disclosed herein, the predetermined form factor of the transposable battery pack may be defined by a configuration that includes a plurality of base battery modules that each includes a base battery module type, and the plurality of base battery modules are each electrically connected to corresponding ones of each of a plurality of transposable battery pack connectors. For the transposable battery pack, the predetermined form factor may be designated as a predetermined external form factor.

A transposable battery pack connector may electrically connect to a battery module connector. The electrical connection may provide for charging of battery cells housed by the battery module, and discharging of the battery cells when the UPS provides power to a load connected to the UPS.

A battery module may be described as a unit that encloses a single or a plurality of battery cells in a casing. The battery module casing may be formed of a plastic, a metal, or from another type of material to enclose the battery cells.

A plurality of battery modules may be dimensioned to fit within the predetermined form factor of the transposable battery pack. The plurality of battery modules may include first, second, and third battery module types that are respectively dimensioned as twice a height, twice a width, and twice the height and twice the width of the base battery module type. For example, the plurality of battery modules may include battery module types that are integer multiples of a height and/or a width of the base battery module type. For example, the integer may be two or three, or another integer. Each of the plurality of battery modules may be electrically connected to a corresponding one of the plurality of transposable battery pack connectors.

With respect to the 1U dimension, other dimensions associated with the UPS may include a rack width of 19 inches (482.60 mm) or 23 inches (584.20 mm). The 19 inches or 23 inches dimensions may represent a width of an equipment mounting-frame in a rack including a frame.

A base battery module may include a 0.5U dimension. For the base battery module, the 0.5U dimension represents approximately ½ of the 1.75 inches (44.45 mm) height of the UPS, minus wall thicknesses of a frame of the UPS. For example, as disclosed herein, the 1U dimension for a UPS represents an approximately 1.75 inches (44.45 mm) height. For a UPS that includes ten base battery modules, the base battery modules of the UPS may be indicated as including a 0.5U dimension. The 0.5U dimension may represent a height of each base battery module of two stacked base battery modules, with it being understood that the 0.5U dimension represents approximately ½ the 1.75 inches (44.45 mm) height of the UPS, minus wall thicknesses of the frame of the UPS.

Also disclosed herein is a UPS including a predetermined internal form factor. The UPS including the predetermined internal form factor may include a plurality of UPS connectors. A UPS connector of the plurality of UPS connectors may be used to electrically connect to a battery module connector. A plurality of battery modules may be dimensioned to fit within the predetermined internal form factor of the UPS. The plurality of battery modules may include first, second, and/or third battery module types that are respectively dimensioned as twice a height, twice a width, and twice the height and twice the width of the base battery module type. Each of the plurality of battery modules is electrically connected to a corresponding one of the plurality of UPS connectors. Further, the predetermined internal form factor of the UPS may be defined by a configuration that includes a plurality of base battery modules that each includes the base battery module type, where each of the base battery modules is electrically connected to corresponding ones of each of the plurality of UPS connectors.

The transposable battery pack including the predetermined external form factor and the UPS including the predetermined internal form factor as disclosed herein may each be configured to be independent of the size of a battery cell, and are usable in case a battery cell size and/or a battery cell capacity changes. For example, with changing battery technology, limitations within cell size, diameter, or even dimensions may not remain constant. With each change in battery cell technology, the transposable battery pack including the predetermined external form factor and the UPS including the predetermined internal form factor as disclosed herein may each include a form factor that remains constant. Thus, a variety of battery modules that are dimensionally related to the base battery module may be transposed as needed within the form factor of the transposable battery pack and/or the UPS. In this regard, the variety of battery modules may be transposed by exchanging battery modules as needed to fit within the form factor of the transposable battery pack and/or the UPS.

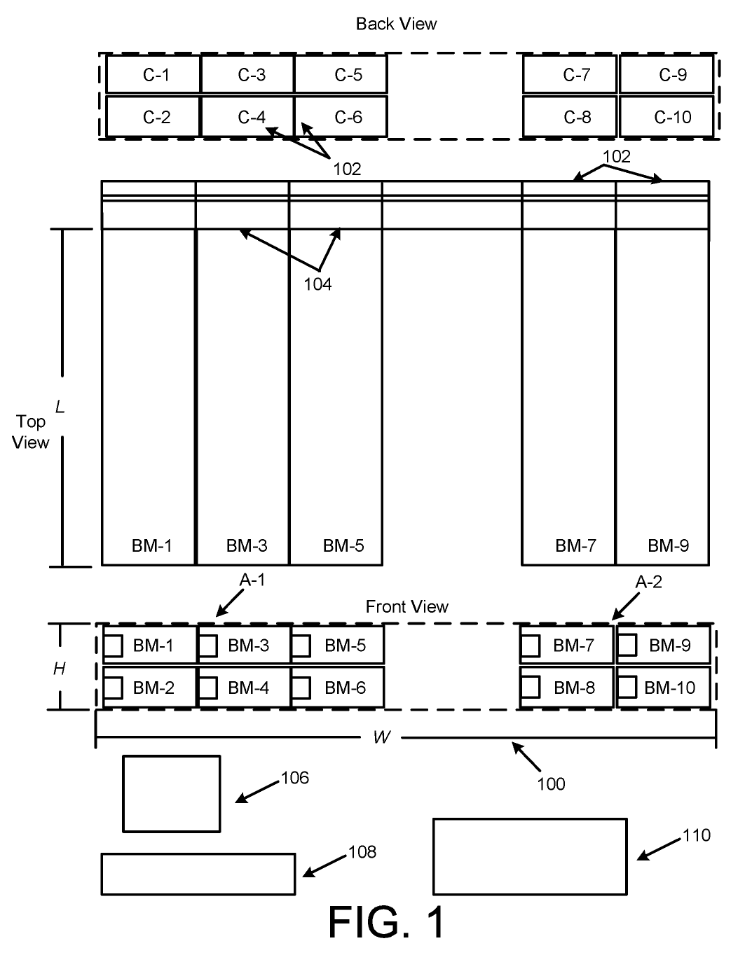

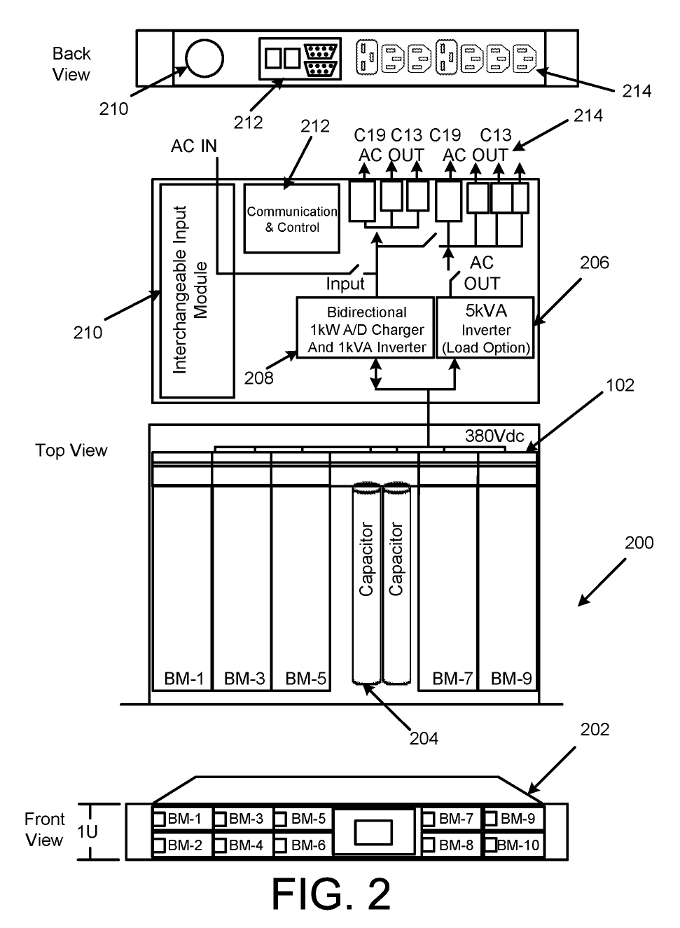

FIG. 1 illustrates front, top, and back views of a transposable battery pack 100 for a UPS 200 (see FIG. 2), and a plurality of battery module types, according to an example of the present disclosure.

Referring to FIG. 1, the transposable battery pack 100 may include a height H and a width W. The height H and the width W may define an area A of the transposable battery pack 100. The transposable battery pack 100 may include a predetermined form factor defined, for example, by the area utilized by battery modules 1-6 and 7-10 (abbreviated as BM-1 to BM-6, and BM-7 to BM-10, in FIG. 1), a length L of the battery modules 1-6 and 7-10, transposable battery pack connectors 102, and battery module connectors 104 as disclosed herein. As shown in the front view of the transposable battery pack 100, the battery modules 1-6 may utilize part of the area A defined by the height H and the width W, designated A-1, and the battery modules 7-10 may utilize part of the area A, designated A-2.

For the transposable battery pack 100, the predetermined form factor may be designated as a predetermined external form factor. That is, because the predetermined form factor for the transposable battery pack 100 is formed by the external surfaces and boundaries of the battery modules 1-6 and 7-10, length L of the battery modules 1-6 and 7-10, transposable battery pack connectors 102, and battery module connectors 104, the predetermined form factor may be designated as a predetermined external form factor.

The predetermined form factor for the transposable battery pack 100 may be defined by a configuration that includes the battery modules 1-6 and 7-10, where each of the battery modules 1-6 and 7-10 is electrically connected to corresponding ones of each of the transposable battery pack connectors 102.

The transposable battery pack connectors 102 may be designated as C-1, C-2, . . . C-10. The transposable battery pack connectors 102 designated as C-1, C-2, . . . C-10 are illustrated in the top and back views of the transposable battery pack 100. Each of the transposable battery pack connectors 102 may electrically connect to a complementary battery module connector 104.

The transposable battery pack 100 may include a plurality of battery modules dimensioned to fit within the predetermined form factor of the transposable battery pack 100. For example, the transposable battery pack 100 may include the battery modules 1-6 and 7-10, each of which may be dimensioned to fit within the predetermined form factor of the transposable battery pack 100. The battery modules 1-6 and 7-10 may be designated as base battery module types.

Further, the transposable battery pack 100 may include a first battery module type 106 that is twice a height of the base battery module type. That is, the first battery module type 106 may be twice a height (i.e., 2× height) of any one of the battery modules 1-6 and 7-10, where each of the battery modules 1-6 and 7-10 is equally dimensioned.

According to another example, the transposable battery pack 100 may include a second battery module type 108 that is twice a width (i.e., 2× width) of the base battery module type.

According to a further example, the transposable battery pack 100 may include a third battery module type 110 that is twice a height and twice a width (i.e., 2× height and 2× width) of the base battery module type.

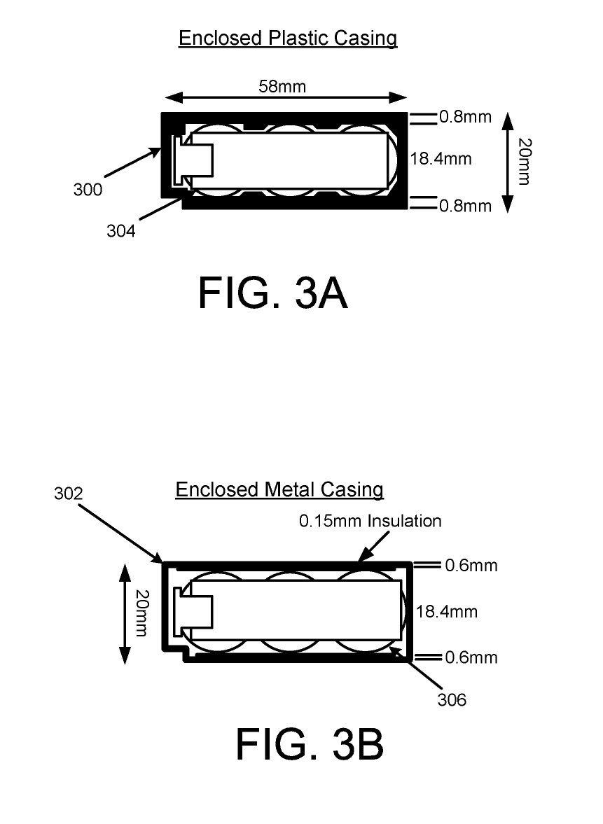

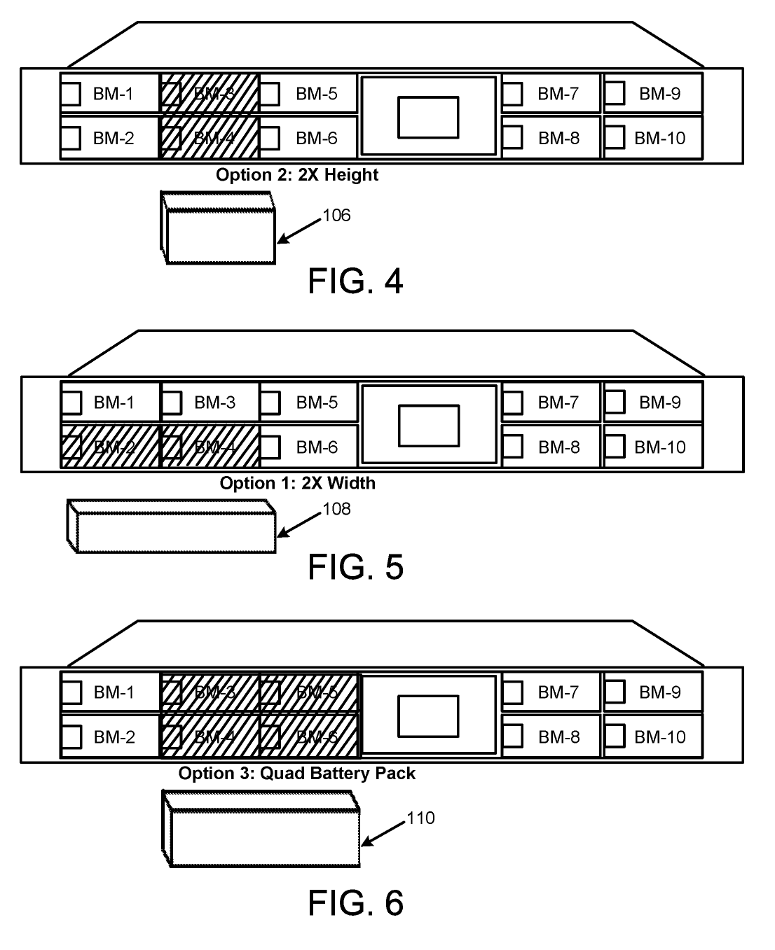

The operation of the battery modules 1-6 and 7-10, and the battery modules 106, 108, and 110 will be described in further detail with reference to FIG. 4, after a description of FIGS. 2-3B.

FIG. 2 illustrates a front view of the transposable battery pack 100 of FIG. 1 installed in the UPS 200, a top view of the UPS 200, and a back view of the UPS 200, according to an example of the present disclosure. Referring to FIG. 2, the UPS 200 may include a frame 202. The frame 202 may include a 1U height. The UPS 200 may include various electrical components such as capacitors 204, inverter 206, bidirectional charger and inverter 208, interchangeable input module 210, communication and control connections 212, and outlets 214.

The capacitors 204 may provide for storage and discharge of charge in association with the battery modules. The inverter 206 may provide for DC/AC conversion from the battery modules to the outlets 214. The bidirectional charger and inverter 208 may provide for AC/DC conversion from the interchangeable input module 210 to the battery modules. The interchangeable input module 210 may be connected to an external source to charge the battery modules. The communication and control connections 212 may include various communication and control connectors that may be used with equipment that is connected to the UPS 200.

Depending on the combination of battery module types that is used as disclosed herein with respect to FIG. 4, each of the battery modules may be electrically connected to a corresponding one of the transposable battery pack connectors 102.

FIGS. 3A and 3B respectively illustrate an enclosed plastic casing 300 and an enclosed metal casing 302 for a battery module of the transposable battery pack 100, according to an example of the present disclosure. Referring to FIGS. 3A and 3B, the casings 300 and 302 of FIGS. 3A and 3B, respectively, may include battery cells 304 and 306, respectively. For the example of FIGS. 3A and 3B, the casings may be dimensioned for a base battery module type.

The transposable battery pack 100 including the predetermined external form factor may be configured independently of the size of a battery cells 304 and 306, and is usable in case a battery cell size and/or a battery cell capacity changes. For example, with changing battery technology, limitations within cell size, diameter, or even dimensions may not remain constant. For example, the size of the battery cells 304 and 306 may increase with respect to diameter, and/or in horizontal and vertical directions in the orientation of FIGS. 3A and 3B. With each change in battery cell technology, the transposable battery pack 100 may include a form factor that remains constant. Thus, as illustrated in FIGS. 4-6, a variety of battery modules that are dimensionally related to the base battery module may be transposed as needed within the form factor of the transposable battery pack. In this regard, the variety of battery modules may be transposed by exchanging battery modules as needed to fit within the form factor of the transposable battery pack.

For example, FIG. 4 illustrates a 2× height battery module type for the transposable battery pack 100, according to an example of the present disclosure. In this case, referring to FIGS. 1 and 4, the base battery modules designated as BM-3 and BM-4 may be replaced with the first battery module type 106, which is a 2× height battery module type. Additionally, each of the base battery modules designated as BM-1 to BM-10 may be replaced with the first battery module type 106.

FIG. 5 illustrates a 2× width battery module type for the transposable battery pack 100, according to an example of the present disclosure. In this case, referring to FIGS. 1 and 5, the base battery modules designated as BM-2 and BM-4 may be replaced with the second battery module type 108, which is a 2× width battery module type. Additionally, each of the base battery modules designated as BM-1, BM-3, BM-7, BM-8, BM-9, and BM-10 may be replaced with the second battery module type 108. If the second battery module type 108 is used exclusively, then the base battery modules designated as BM-5 and BM-6 may be replaced with the first battery module type 106, and/or remain unchanged.

FIG. 6 illustrates a 2× height and 2× width battery module type for the transposable battery pack 100, according to an example of the present disclosure. The 2× height and 2× width battery module type may also be designated as a quad battery module type. In this case, referring to FIGS. 1 and 6, the base battery modules designated as BM-3, BM-4, BM-5, and BM-6 may be replaced with the third battery module type 110, which is a 2× height and 2× width battery module type. Additionally, the base battery modules designated as BM-7, BM-8, BM-9, and BM-10 may be replaced with the third battery module type 110. If the third battery module type 110 is used exclusively, then the base battery modules designated as BM-1 and BM-2 may be replaced with the first battery module type 106, and/or remain unchanged.

Referring to FIGS. 1 and 4-6, depending on factors such as availability and need, various ones of the base battery modules may be replaced with different combinations of battery modules that include the base battery module type, the first battery module type 106, the second battery module type 108, and the third battery module type 110.

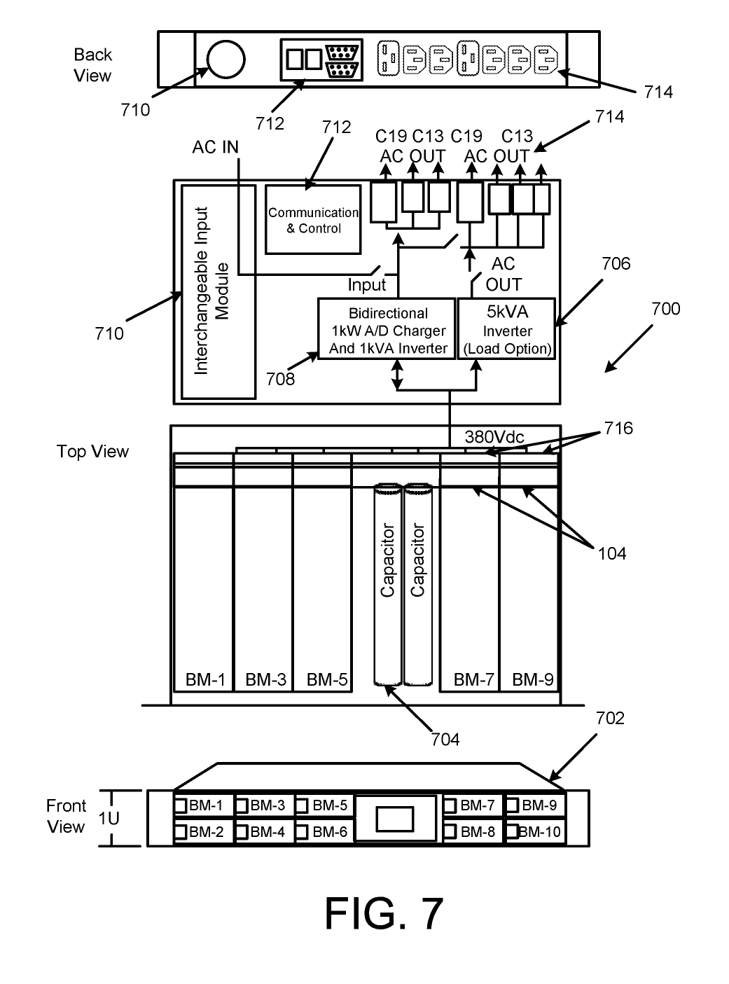

FIG. 7 illustrates a front view of a UPS 700 including a predetermined internal form factor, a top view of the UPS, and a back view of the UPS, according to an example of the present disclosure.

Referring to FIG. 7, the UPS 700 may include a predetermined internal form factor. The UPS 700 may include a frame 702. The frame 702 may include a 1U height. The UPS 700 may include various electrical components such as the capacitors 704, inverter 706, bidirectional charger and inverter 708, interchangeable input module 710, communication and control connections 712, and outlets 714.

The UPS 700 may include a plurality of UPS connectors 716. The UPS connectors 716 may be shaped similar to the transposable battery pack connectors 102, which are illustrated as C-1 to C-10 in FIG. 1. Each of the UPS connectors 716 may electrically connect to a battery module connector 104.

In a similar manner as disclosed herein with respect to FIGS. 1-6, a plurality of battery modules may be dimensioned to fit within the predetermined internal form factor of the UPS 700. The plurality of battery modules may include the base battery modules (designated as BM-1 to BM-10), the first, the second, and/or the third battery module types that are respectively dimensioned as twice a height, twice a width, and twice the height and twice the width of a base battery module type. The first, the second, and/or the third battery module types are disclosed herein with respect to FIGS. 1 and 4-6.

Each of the plurality of battery modules may be electrically connected to a corresponding one of the plurality of UPS connectors 716.

The predetermined internal form factor for the UPS 700 may be defined by a configuration that includes a plurality of base battery modules that each includes the base battery module type and are each electrically connected to corresponding ones of each of the plurality of UPS connectors 716.

The predetermined form factor for the UPS 700 may be designated as a predetermined internal form factor because the predetermined form factor for the UPS 700 is formed by the internal areas of the UPS that are defined by the external surfaces and boundaries of the battery modules 1-6 and 7-10, length L of the battery modules 1-6 and 7-10, UPS connectors 716, and battery module connectors 104, when the base battery modules are connected to corresponding ones of each of the plurality of UPS connectors 716.

As disclosed herein, the UPS 700 including the predetermined internal form factor may be configured independently of the size of a battery cell, and is usable in case a battery cell size and/or a battery cell capacity changes. With each change in battery cell technology, the UPS 700 including the predetermined internal form factor may include a form factor that remains constant. Thus, as illustrated in FIGS. 4-6, a variety of battery modules that are dimensionally related to the base battery module may be transposed as needed within the form factor of the UPS 700. In this regard, the variety of battery modules may be transposed by exchanging battery modules as needed to fit within the form factor of the UPS 700.

What has been described and illustrated herein is an example along with some of its variations. The terms, descriptions and figures used herein are set forth by way of illustration and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A transposable battery pack for an uninterruptible power supply (UPS), wherein the transposable battery pack includes a height and a width dimensioned to fit within a frame of the UPS, and wherein the transposable battery pack includes a predetermined form factor, the transposable battery pack comprising:
a plurality of transposable battery pack connectors, a transposable battery pack connector of the plurality of transposable battery pack connectors to electrically connect to a battery module connector; and
a plurality of battery modules dimensioned to fit within the predetermined form factor of the transposable battery pack, wherein the plurality of battery modules includes at least one of first, second, and third battery module types that are respectively dimensioned as twice a height, twice a width, and twice the height and twice the width of a base battery module type, wherein
each of the plurality of battery modules is electrically connected to a corresponding one of the plurality of transposable battery pack connectors, and
the predetermined form factor is defined by a configuration that includes a plurality of base battery modules that each includes the base battery module type and are each electrically connected to corresponding ones of each of the plurality of transposable battery pack connectors.

2. The transposable battery pack according to claim 1, wherein the UPS is a 1U dimension-based UPS.

3. The transposable battery pack according to claim 1, wherein the base battery module type includes an approximately 0.5U height relative to a 1U frame height of the UPS.

4. The transposable battery pack according to claim 1, wherein the predetermined form factor is dimensioned to substantially fit ten base battery modules.

5. The transposable battery pack according to claim 3, wherein the predetermined form factor is dimensioned to substantially fit ten base battery modules.

6. A transposable battery pack for an uninterruptible power supply (UPS), wherein the transposable battery pack includes a height and a width dimensioned to fit within a frame of the UPS, and wherein the transposable battery pack includes a predetermined form factor, the transposable battery pack comprising:
a plurality of transposable battery pack connectors, a transposable battery pack connector of the plurality of transposable battery pack connectors to electrically connect to a battery module connector; and
a plurality of battery modules dimensioned to fit within the predetermined form factor of the transposable battery pack, wherein the plurality of battery modules includes a base battery module type, and battery module types that are dimensioned as integer multiples of at least one of a height and a width of the base battery module type, wherein
the integer is greater than one,
each of the plurality of battery modules is electrically connected to a corresponding one of the plurality of transposable battery pack connectors, and
the predetermined form factor is defined by a configuration that includes a plurality of base battery modules that each includes the base battery module type and are each electrically connected to corresponding ones of each of the plurality of transposable battery pack connectors.

7. The transposable battery pack according to claim 6, wherein the integer is two or three.

8. The transposable battery pack according to claim 6, wherein the base battery module type includes an approximately 0.5U height relative to a 1U frame height of the UPS.

9. The transposable battery pack according to claim 6, wherein the predetermined form factor is dimensioned to substantially fit ten base battery modules.

10. An uninterruptible power supply (UPS) including a predetermined internal form factor, the UPS comprising:
a plurality of UPS connectors, a UPS connector of the plurality of UPS connectors to electrically connect to a battery module connector; and
a plurality of battery modules dimensioned to fit within the predetermined internal form factor of the UPS, wherein the plurality of battery modules includes battery module types that are dimensioned as integer multiples of at least one of a height and a width of a base battery module type, wherein
the integer is greater than one,
each of the plurality of battery modules is electrically connected to a corresponding one of the plurality of UPS connectors, and
the predetermined internal form factor is defined by a configuration that includes a plurality of base battery modules that each includes the base battery module type and are each electrically connected to corresponding ones of each of the plurality of UPS connectors.

11. The UPS according to claim 10, wherein the integer is two or three.

12. The UPS according to claim 10, wherein the UPS includes a 1U frame height.

13. The UPS according to claim 12, wherein the base battery module type includes an approximately 0.5U height relative to the 1U frame height of the UPS.

14. The UPS according to claim 10, wherein the predetermined internal form factor is dimensioned to substantially fit ten base battery modules.

15. The UPS according to claim 10, wherein the plurality of battery modules further includes the base battery module type.
